(19) United States
(12) Patent Application Publication
(10) Pub. No.: US 2007/0170798 A1
(43) Pub. Date: Jul. 26, 2007

(54) Levitation device

(76) Inventors: Arthur Gohin, Aubusson (FR); Janick Simeray, Argenteuil (FR); Wang Xiao Bing, FuTian (CN); Li Liang Qing, FuTian (CN)

Correspondence Address: KENYON & KENYON LLP, ONE BROADWAY, NEW YORK, NY, 10004, US

(21) Appl. No.: 11/592,464

(22) Filed: Nov. 2, 2006

(30) Foreign Application Priority Data
Nov. 2, 2005 (FR) 0511142
Mar. 24, 2006 (FR) 0602602
Apr. 18, 2006 (CN) 200620019190.2
Apr. 18, 2006 (CN) 200610075825.5
Mar. 24, 2006 (CN) 200620007698.0
Mar. 24, 2006 (CN) 200610066175.8
Mar. 17, 2006 (CN) 200610065336.1
Mar. 10, 2006 (CN) 200620008726.0

(51) Int. Cl. H02K 7/09; H01H 47/00

(52) U.S. Cl. 310/90.5; 361/144

(57) ABSTRACT

Device of levitation of an item over an optimized base by means of permanent magnets. The equilibrium is stable along one or two axes by means of these permanent magnets, and along the one or two others by means of a combination of electromagnets of near zero consumption at equilibrium.

### FIELD OF THE INVENTION

The invention relates to the principle and the realization of a magnetic levitation device for various items, without overturn of said device.

This device is applicable to items of decoration, advertising communication, or with industrial applications that require the levitation of an item.

### BACKGROUND INFORMATION

The state of the art for levitation devices comprises items in magnetic lift such as globes. These devices comprise a magnet at their top (at the North Pole for a globe) and are suspended under a magnet; wherein an electromagnet controls the levitating objects attraction in order to maintain a constant distance between item and the holder. These conventional systems control the electromagnet through the measurement of the magnetic field produced by the item at the level of the holder. The field at the level of the holder is measured by means of a Hall Effect sensor that delivers a tension proportional to the measured magnetic field.

### SUMMARY OF THE INVENTION

According to the present invention the levitating item is not suspended under a magnetic device but levitates over a base that comprises sources for the magnetic field.

According to the present invention, the levitating item can be heavy. The levitation process is also completely quiet. The surface above which the item levitates is flat or at least regular. The space between the surface and the item is free and empty of any device. The arrangement implemented for the levitation is discreet or even not perceivable. The levitating item is also stable concerning turn-over.

According to exemplary embodiments of the invention, the levitating item is in rotation around the vertical or tilted axis, free or maintained. The levitation consumes little energy, or is permanent or at least autonomous (i.e. power supply independent) over a long time duration.

U.S. Pat. No. 4,585,282 provides for a levitation of an item from underneath means of a permanent magnet set (FIG. 13), but the set does not aim to stabilize the item versus turn over (column 4 lines 6 to column 5 lines 11). As provided in U.S. Pat. No. 4,585,282, the pyramid, for proper support as a levitated element must be stabilized against movement in a number of modes, the principal-ones are defined as follows: mode 1 refers to vertical or axial motion, up or down from the null position; mode 2 is principally translational motion from side to side relative to the side position, although it includes an element of pivoting of the pyramid as the pyramid deviates transversely from the null position; mode 3 is principally a tilting mode from some center of pivoting within the pyramid. Each of these modes involves oscillation relative to the null position, which oscillation is damped under the influence control circuitry. Modes 1, 2 and 3 can have, for example, the resonant frequencies 1.5, 1 and 5 Hz respectively.

U.S. Pat. No. 4,585,282 only considers the possibility of a vertical stability and a horizontal instability, excluding the possibility of others (column 2, lines 30-68). In this situation, an oscillating mode 2 is only produced when a servo-control is active. The Ernshaw theorem, however, makes these oscillations impossible in mode 2 when only permanent magnets are engaged. Thus the aim and result of this set of permanent magnets does not separate the translational stability from the turn over stability. As a result, without corrective coils, the levitating item turns up side down, falls rapidly on the base and gets stuck on it.

The above mentioned modes 2 and 3 exist in the two perpendicular directions of the horizontal plane. Thus, this situation requires at least 4 independent corrective coils compared to the 1 or 2 coils in the present invention, where the levitating item is stable versus turn over by permanent magnets only. The present invention achieves this goal by prohibiting a sufficient precision of the shape and proportion of the magnets both in the base and the levitating item.

U.S. Pat. No. 4,585,282 mentions movement modes defined as non principal modes. These modes would require supplementary coils in order to stabilize the corresponding movements. The system implies no more than 5 independent modes whatever the magnetic situation is, three translations and two rotations (turn over), since the vertical axis corresponds to a free rotation. As provided above, mode 2 and 3 are double. Thus said, non-principal modes must be a combination of the 1, 2 and 3 modes, and this shows that the movement of the levitating item is not understood.

Second, the corrective coils of U.S. Pat. No. 4,585,282 are not independent: each pair is given only one current thus a total of two currents. As a result, it is then impossible mathematically to control a four dimensional instability. Moreover, these coils are located essentially in order to get the turn-over stability and only correct extremely weak shifts from the translational equilibrium point. So these coils cannot correct the translational shift in normal every day situations. This system would require a user to locate an exact translational equilibrium point, and no solution is given for that.

Third, these coils are in place where they cannot accept iron cores wherein said iron cores would trap the magnetic field on the top of the base crown and lead it sideways from where it goes directly to the bottom side of the base crown, thus without touching the levitating item that then wouldn't levitate any more. Without iron cores, the currents of the coils have to be very high to the point that they exclude a permanent use. Since the permittivity of iron can reach a value of 1000 easily, due to the absence of the iron, the force provided by a coil in this configuration is reduced by a factor 1000, and consequently this does not allow any compensation of the magnetic instability.

The goals of the present invention, however are achieved, with the magnets currently available as provided in the arrangements described and illustrated herein, such magnets being neodymium Iron Bore alloy units.

The strength of the coil with no iron component and with a current large enough so that the coil heat 50° C. more that ambient temperature can only compensate an upper magnet drift of a mere 10 micron away from the center in one horizontal direction. This means it becomes impossible to stabilize the levitating device against any environment perturbation and drifts. The description is not sufficient to reach the goal of the present invention. In consequence, no application of the technology provided in the present invention has ever been demonstrated.

U.S. Pat. No. 4,585,282 uses oscillating circuits for the measurement of the levitating item displacements, but does not apply it to the detection of the exact equilibrium points. This requirement is essential for minimizing the power consumption, because this equilibrium point is not permanent. This point moves with the temperature, because magnets are not stable with the temperature, with the influence of magnetic sources around, with the influence of iron around, and with the fact that the levitating device can be put on a non horizontal surface.

Chinese patent CN2569440Y describes an automatic static magnetic levitation system for equilibrium, having a base and a levitating element. This system makes use of the magnetic repulsion produced by the magnet positioned in the base to balance said levitating element with a magnet in it above said base. The levitating element in this magnetic levitation system, however, must contain two connected levitating permanent magnets arranged horizontally such that the system usually can only levitate oblong items and the levitating item is not able to rotate horizontally around the vertical axis of its center.

Chinese patents CN115607C, CN2726048Y and CN1267121A describe some other different types of magnetic levitation systems mentioned above that are not able to levitate an element above a base and make said element rotate freely and horizontally.

U.S. Pat. No. 5,168,183 describes a device which claims lift above a source of magnetic field, different than the current invention. The difference between the present invention and this document is better understood in the light of the physical constraints of the magnetic levitation.

A theorem attributed to Ernshaw proves it impossible to obtain a static levitation by using a combination of fixed magnets. The static levitation implies a stable suspension of one item against gravity.

Magnetostatic and gravitational energies Em, Eg and total E of any system are given by:
Em=∫ym.B dv, Eg=∫ρP dv, E=Em+Eg=∫ym.B+ρP dv

Where m and ρ are the density of magnetic moment and of mass of the levitating item, B and P are the local magnetic fields and gravitational potential.

We call X, Y and Z the coordinates of the center of gravity of the item to be put in levitation. Equilibrium in a direction X takes place when the first derivative of E according to X from is zero, and this equilibrium is stable or unstable with respect to small displacements according to whether the second derivative of E according to X is positive or negative, that is whether:
∂²E/∂X²>0, or ∂²E/∂X²<0
and the same according to Y and Z. However (1)
   ∂²E/∂X²+∂²E/∂Y²+∂²E/∂Z²=∫y(m(∂²/∂X²+∂²/∂Y²+∂²/∂Z²)B+ρ(∂²/∂X²+∂²/∂Y²+∂²/∂Z²)P)dv=0
since in steady state the laplacians of B and P are zero outside of the matter which is their source.

The sum of these three stability criteria is thus necessarily zero: whatever is the choice of three axes perpendicular between them, the item is always unstable in one or two directions at most, and the more it is stable in a direction the more it is unstable in the two others.

This theorem applies even to the flexible and paramagnetic items (but not to the diamagnetic ones). They will be always unstable with respect to translation motions of the whole item for any equilibrium position.

U.S. Pat. No. 5,168,183 describes several implementations of levitation devices, that circumvent the limits of the Ernshaw theorem by means of variable magnetic fields which make it possible to control the position of the sustained item.

According to the presented principles, the item, a magnet, is stable in a horizontal plane by fields delivered by several permanent magnets, but unstable on a vertical axis, and stabilized by an electromagnet controlled by a measure of location of the item.

In both cases, the magnet is unstable in rotation. Indeed the sustained magnet turns over spontaneously such that it gets stuck to the permanent magnets, and no solution is indicated to prevent this condition. It is explained how to prevent overturning by connection of 2 or more levitating magnets over 2 or more bases. This systems, however limits the lift efficiency, as in compactness, and completely exposed to the viewer. Additionally, these conventional systems do not account for the effect of gravity on the items, nor the consequence which this gravity can have on the stability of the levitation. As it is, the expert seems to have to implement this levitation in weightlessness, which reduces considerably the capability of U.S. Pat. No. 5,168,183. It specifies well indeed that the device works independently of ambient gravity, and it is indeed very ineffective according to the described means if not in weightlessness. With NdFeB magnets it appears impossible that the best ferromagnetic alloys now available could carry just themselves in the bearing zone given by the magnet devices indicated (FIGS. 5, 6 and 10, 11, U.S. Pat. No. 5,168,183).

These deficiencies, however, are foreseeable for the conventional systems since unstable equilibrium along the axis X (perpendicular to in the plan of stability) stays at a distance from the magnets necessarily definitely larger than that of the bearing zone commonly used. Then, the field of gravity moves this equilibrium point even further from the magnets, however, the magnetic bearing decreases extremely rapidly with the distance to the magnets. Consequently, these conventional systems are intended for the applications in low or zero gravity.

FIGS. 4 and 5 respectively represent the potential of a magnetic tore without and with the gravitation. The higher and lower curves correspond globally respectively to the situation of the U.S. Pat. No. 5,168,183 and to that of this invention. The points of unstable equilibrium 41 and 51 are thus provided in the U.S. Pat. No. 5,168,183 and the points of steady equilibrium 42 and 52 are those of the present invention. Clearly the stability is much weaker for 51 than for 52.

Stabilizing Device

The equation of a one-dimensional motion in the X direction of a mass m in a potential field E(X) with a dampening force D(∂X/∂t) and a random force R(t) is given by:
m∂²X/∂t²=−∂E/∂X+D+R (2)

In our case the random force is due to air streams and electronic noise, and the dampening force D is basically due to the air viscosity thus linear versus velocity:
D=−a∂X/∂t (3)

This gives a stable equilibrium if ∂²E /∂X²>0, or an unstable one if ∂²E/∂X²<0

The state of art method consists in adding a corrective potential C(X) that brings the item back to its equilibrium point as soon as it leaves it: it is such as
∂C/∂X=0, and
∂²C/∂X²>−∂²E/∂X², which we write with a simpler notation:
c>e (4)

Supposedly this uses no more power than the random force R requires. But practically C(X) cannot be exactly centered on X=0, but on X₀≠0. Then the equilibrium point is not at X=0 but at X=(c/(c+e)) X₀; providing a real disadvantage in that a force (c²/(c+e)) X₀ must constantly be created by the corrective system, and this is energy consuming.

For instance levitating 100 g requires easily several watts for stabilizing the equilibrium along each dimension needing it.

### BRIEF DESCRIPTION OF THE DRAWINGS

FIGS. 1 and 1a are cross sections of the present invention.

FIG. 2 is a circuit amplifier for the invention of FIG. 1.

FIG. 3 is a perspective view of the present invention of FIG. 1.

FIG. 4 is a graph of magnetic potential the present invention without gravitation.

FIG. 5 is a graph of magnetic potential the present invention with gravitation.

FIG. 6 is an electronic schematic drawing including 2 Hall Effect sensors preventing influence of electromagnets of FIG. 1 is an optimized way to process a Hall Effect signal and to suppress the power in the coils.

FIG. 7 is a cross section of the present invention.

FIG. 8 is a cross section of electromagnets of FIG. 1.

FIG. 9 is a suppression arrangement for a base of the invention of FIG. 1.

FIG. 10 is a full crown of a base of FIG. 1.

FIG. 11 is an electronic schematic drawing including coils preventing influence of electromagnets of FIG. 1.

### DETAILED DESCRIPTION

Consequently, the present invention aims at carrying out the levitation of an item stable in rotation along an unspecified horizontal axis (turn over), by magnets in repulsion along the vertical direction, making possible free rotation around the vertical axis or a tilted axis, and or making possible permanent rotation, optimizing the levitation distance.

In the present invention, the free rotation around the vertical axis is obtained by using a set of magnets with cylindrical symmetry inside the base and/or inside the levitating item. The free rotation around the tilted axis is obtained by using an arrangement of magnets with cylindrical symmetry inside the levitating item only, whereas a dissymmetry is introduced in the base set of magnets in order to produce a tilted magnetic field at the equilibrium point of the levitating item.

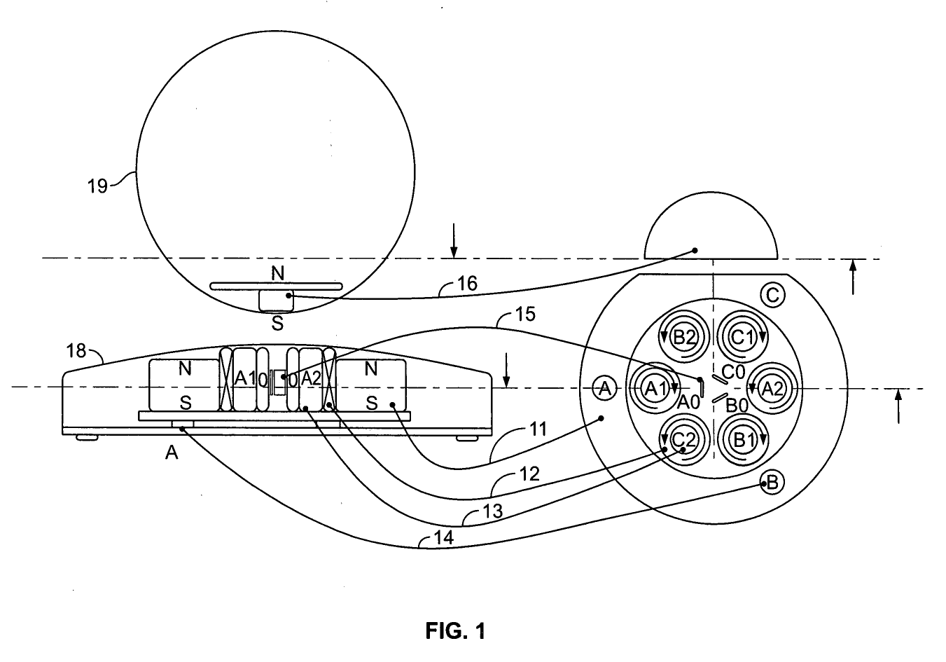

The present invention relies on the use of a magnet similar to a tore, for example in the shape of a disc with a circular hole in it. Such a magnet is placed in the base, as shown in FIG. 1, its plane is horizontal and its polarity is vertical. One can replace it with a set of substantially identical magnets with same polarity and placed regularly on a circle, provided that the levitating set of magnets has a cylindrical symmetry if one wants the free rotation of the levitating item.

When the base magnet has a cylindrical symmetry, the levitating set of magnet is free to have or not to have the cylindrical symmetry.
Three basic exemplary embodiments are presented:

1—Translational stability along the vertical axis, translational instability along the two horizontal axes.

2—Translational stability along the vertical axis and one horizontal axis, translational instability along the second horizontal axis.

3—Translational stability along the horizontal axes, translational instability along the vertical axis.

According to an exemplary embodiment of the invention, stability is obtained without other electric consumption than that of the sensors that control the maintaining devices; these sensors and devices are selected according to their intrinsic low power, in order to make possible long duration autonomy by batteries or total autonomy by solar collector associated with a refillable battery.

The implementation of a permanent supply by a converter of the domestic tension also returns in the item of the invention. Consequently electric low power becomes a criterion of low cost for the converter.

### 1—Translational Stability Along the Vertical Axis, Translational Instability Along the Two Horizontal Axes

FIG. 1 is described in a nonexclusive example of this basic exemplary embodiment. Reference element 11 is a crown magnetized vertically, for example north upwards, set in the base.

This crown pushes up a magnet 16 in the levitating item, whose north is with the top, because the lines of the field of magnet 11 are folded up in this zone.

Concerning the base, one may use a large and thick crown. For example, the largest is the amount of magnetic matter required for the highest distance the levitating item is to raise. In an exemplary embodiment of the present invention, the ratio outer/inner radius of the crown is best at about two for both the rotational stability and the minimal translational instability in the horizontal plane. This crown can be as thick as wide but not much more since the crown effect diminishes with the height.

Concerning the levitating item, the weight is compensated by the arrangement so the central magnet must be flat so that the magnetic matter stays as near as possible to the base for a maximum levitating force.

The central magnet can be as large as the central hole of the base crown. This means that the levitating magnetic matter can be a continuous disc that changes its polarity for a radius equal to the inner radius of the base crown.

In that case, the stability in rotation around an horizontal axis of a central magnet is optimized if the diameter of the central magnet is the same as the inner diameter of the base's tore, and if this magnet is flat.

If the diameter is lower, it remains stable, but stability is lower in proportion with the diameter ratio.

When the turn-over stability is too weak, the levitating crown can be reinforced but also the central magnet polarity can be inverted and so be the same as the polarity of the crown. All this remains true for case 2.

In this embodiment at least two independent servo systems maintain stable the position of the item in the horizontal plane.

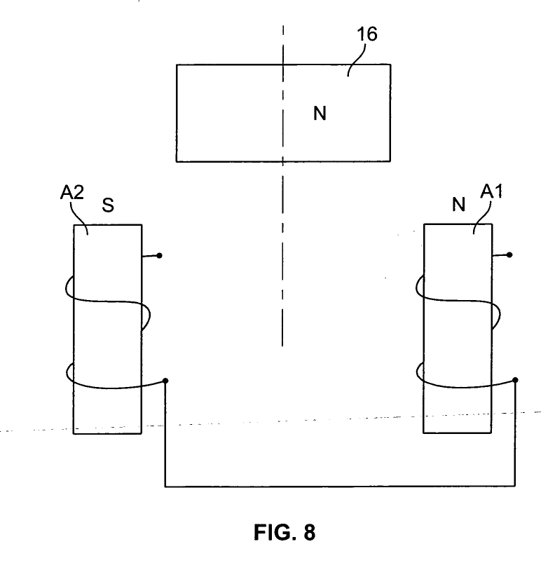

The base comprises also for instance three electromagnets: A1, B1 and C1, or six: A1, B1, C1, A2, B2, and C2 (FIG. 1) whose role is to modify the magnetic field of the base according to the position of the levitating item. In the case of an even number of electromagnets, these are connected in opposition so that opposite currents go through them, in order that they have opposite polarity (FIG. 8).

The core of the electromagnet is made of iron with low hysteresis, and high permittivity, so that it optimizes the magnetic field emitted. The present invention may use, for example, iron, with permittivity around 1000, a magnet which levitate 5 mm above form the center point to be pulled back to the center with reasonable currents that not heat the coil.

The core of the electromagnet can easily be saturated from the magnetic field issued from the base and item sets of magnets. The latter appears to be the more important, and as a result the efficiency of said core can reduce to 1/30 of its normal value. This saturation can be cancelled by setting magnetic rods against the windings whose polarity is chosen in order to give the opposite saturation.

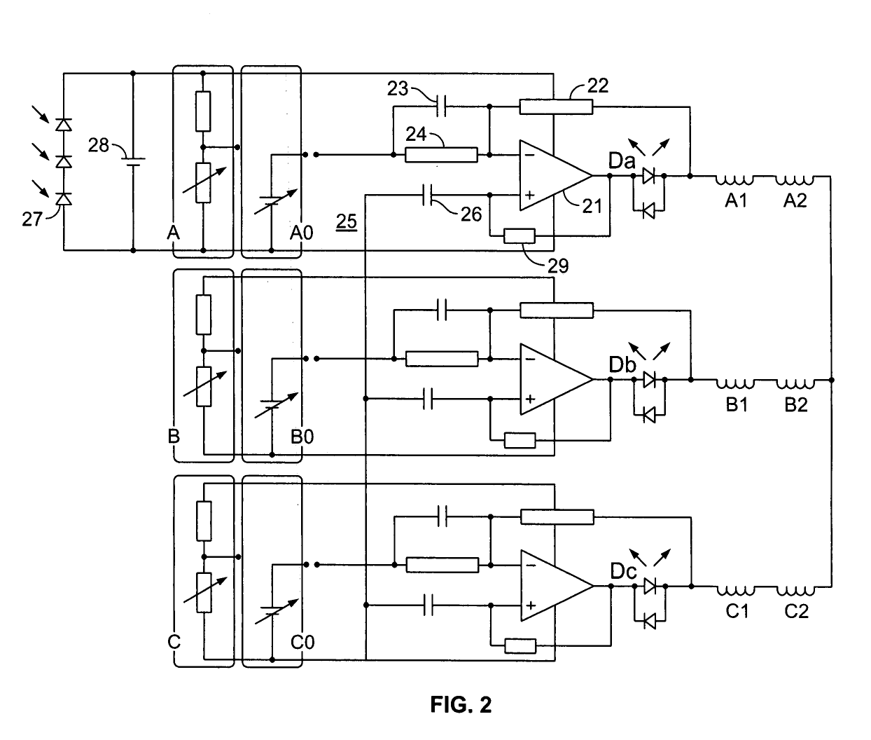

FIG. 2 describes the signal amplification circuit given by the sensors A, B and C, or A0, B0 and C0. The amplified signals are sent to the above-mentioned electromagnets.

According to the present invention, if the item shifts towards the left of FIG. 1 then A1 presents a repulsive south pole in facing the south pole of magnet 16.

It should be noted that according to the geometry presented on FIG. 1, the item is stable along the vertical axis, stable for the turning over around the two horizontal axes, but unstable for the translation in the horizontal plane.

Consequently, a micro horizontal translation is corrected by the opposition of the south poles of 16 and A1.

According to a non restrictive exemplary embodiment of the invention with 6 electromagnets, a translation towards the left is compensated by the combination of the action of a south pole of A1 and a north pole of A2. Each electromagnet is produced by a copper winding 12 and of a ferromagnetic core 13.

A stabilization of the position of the item may also be achieved by giving the axis electromagnets a horizontal orientation pointing towards the center of the lifting magnets.

The force of stabilization exerted on the central magnet of the levitating item depends on the polarity of the electromagnets, however, this horizontal orientation of the electromagnets makes them exert moreover a couple of forces on the base crown; one holds account of this when one uses pressure sensors under the base crown.

According to a nonexclusive exemplary embodiment, the displacement of the levitating item in the horizontal plane is measured by two sensors A or more, of variable resistor type according to the pressure. It comprises two electrodes in contact with a polymer charged with carbon whose resistance decreases according to the imposed pressure.

Such a sensor, for example, is provided by the company ®Interlink electronics under the name of ®FSR, force sensing resistor. Model 402, for example, has with no load a resistance of 10 MΩ and its conductivity is proportional to the exerted pressure or the exerted force. For about 100 g resistance falls to 30 kΩ, which means a current consumption of 0.1 mA for 3 V.

The tension measured between this sensor and another resistance of 30 kΩ for example, thus varies linearly according to the weight exerted on this sensor.

The sensor can also be a strain gauge, a capacitive sensor, etc. The micro displacement of the item towards the left induces an increase in the pressure on sensor A, a reduction on B and C, therefore a fall of resistance A, and measured tension of A. FIGS. 1 and 2 increase out of B and C, this because the center of gravity of the whole structure supported by sensors A B and C moves towards the left.

According to this nonexclusive exemplary embodiment of the invention, consumption related to the sensors of forces is lower than 0.3 mA for 3 sensors.

Advantageously, in order to use the pressure sensors under the best conditions of sensitivity and precision, the lifting magnets of the base are placed on a common plate, held by adjustment screws that support it through flexible intermediaries such as springs or rubbers. The pressure sensors are also fixed at the aforementioned common plate, but with intermediaries substantially more rigid.

Thus, with the adjustment screws, the pressure withstood by the pressure sensors may be adjusted in the middle of their operation range.

The adjustment screws can be distributed around the center of gravity of the whole lifting magnets base with their common plate, and can also consist of a single screw placed under the aforementioned center of gravity. The pressure sensors are all the more placed near of the aforesaid center of gravity that they are wished sensitive to the displacement of the item placed in levitation.

Two fixing modes of the electromagnets are possible:
fixed together with the lifting magnets of the base. In this case, the electromagnets transmit to these magnets, and thus to the sensors, a reaction force opposed to that transmitted to the levitating item.
Fixed at the base independently of the base crown. In this case, they exert on it, thus on the sensors, forces proportional to the current that goes through them. These forces can be removed mechanically when the electromagnets are in vertical position.

In both cases it can be necessary to hold account of this in the treatment of the signal.

According to another nonexclusive exemplary embodiment of the invention the displacement is measured by means of Hall effect probes A0, B0 and C0. Probe SS49 of ®Honeywell has a good sensitivity stability and linearity in weak fields, and may be used.

According to the invention, in this exemplary embodiment, a displacement of the item towards the left can be measured without interference by a A0 probe placed in a zone non affected by the lines of field of the electromagnets A1, B1, C1 and A2, B2, C2.

This zone is at the center of the electromagnets crown. A displacement towards the left of the item increases the horizontal component of the magnetic field of 16, which decreases the output voltage of probe.

Probe SS49 consumes 5 mA; for three sensors A0, B0 and C0: 15 mA, for example.

The continuation of the principle is described FIG. 2. Sensor A or A0 generates a fall of tension which is derived by a condensator 23, and transmitted by a resistance 24. The sum of the derivative and of the signal is then amplified by the operational amplifier 21 associated with resistance 22.

The exit of the amplifier supplies the electromagnets A1 and A2 in proportion, in a direction, that compensates for the micro displacement. Resistance 29 and condensator 26 give a reference voltage common to the amplifiers.

In addition to compensating for the displacement, by creating a pulling back force, this device comprises a damping function in order to make impossible the maintenance of oscillation.

The function of damping is related to condensator 23. It makes it possible to oppose to any fast displacement of the item.

A fast and weak noise operational amplifier as the LMV 651 of ®National Semi conductor consumes only 0.1 mA and is used in the exemplary embodiment.

The electric consumption of the three amplifiers is then reduced to approximately 0.3 mA.

According to the invention the electromagnets consume only exceptionally.

When the globe is centered and at equilibrium, the electromagnets are traversed by no current.

The consumption of the circuit is 0.6 mA if the sensors are force sensors and 15 mA if the sensors are probes with Hall Effect arrangements.

Equilibrium is obtained with null consumption of the electromagnets if the sensors give all the same tensions. As this is difficult, the combination of three arrangements makes it possible to carry out this condition.

Adjusting devices consisting in the mollettes Va, Vb and Vc allow the orientation of the base. The imbalance of the sensors A, B, C or A0, B0, C0, involves a compensation current in the electromagnets. This average current is then visualized by the electroluminescent diodes Da, Db, Dc.

According to the principle, the user turns the mollettes until extinguishing the three diodes Da, Db, Dc. Then, the residual error of non-zero average is compensated by the resistance 29 which shifts the reference of the amplifier slowly, so that on average, the amplifier does not deliver any current. The user finds the position of balance for each mollette between the two positions where a diode starts to shine.

According to this process, the whole electric consumption is reduced to 0.6 mA on average with the use of sensors of force.

In addition one can consider the diodes D for the lighting.

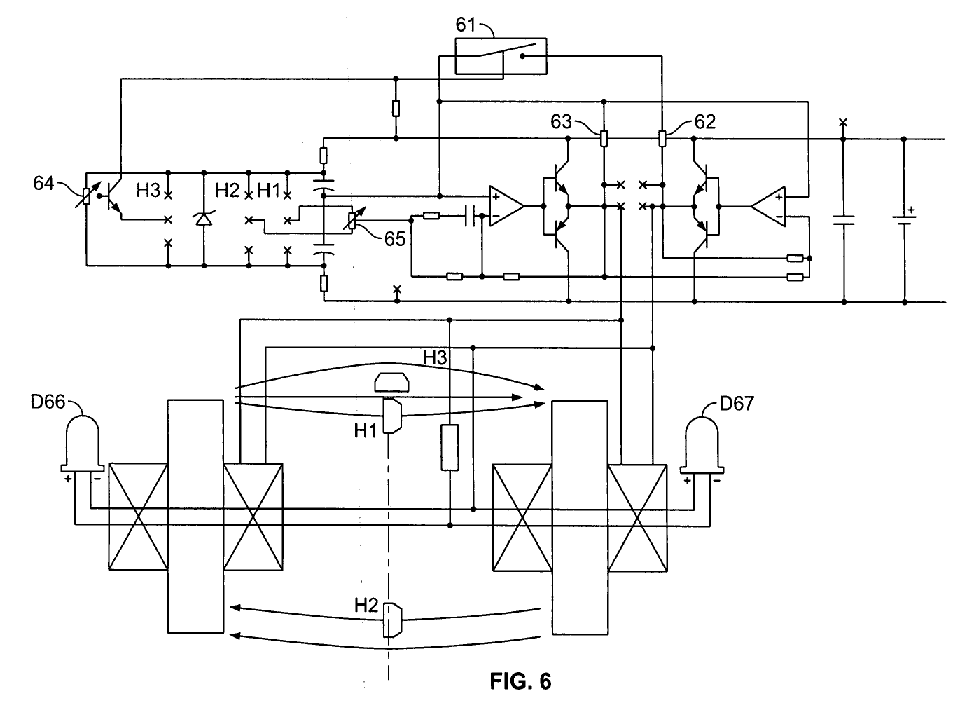

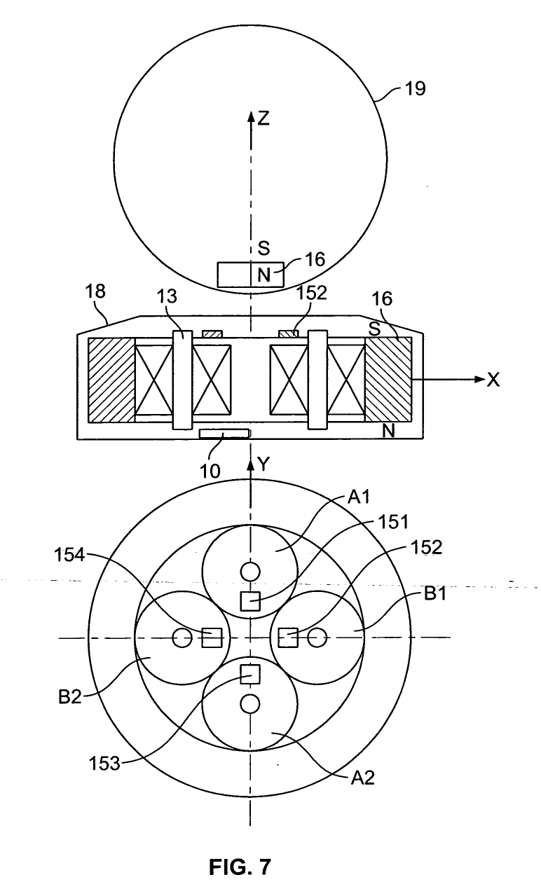

FIG. 6 describes an arrangement to completely suppress the coils consumption either when the levitation item is over the base and when it is not over the base. The design presented is associated with one axis of stabilization, if there are 2 axes to stabilize, then this design is operated 2 times.

One Hall Effect sensor H3 detects the presence and the absence of the levitating item, and then controls the electronic switch 61. If there is no levitating item, then the switch 61 must be open, it means the voltage injected in the condensators and +input of the amplifiers through the resistor 62 make a counter reaction. This allows to suppress the current in the coil completely.

If there is a levitating item over the base, with a position not exactly on the top of the energy curve, then there is a force emitted by the coils to pull the item back into the top. For reaching the top, the strategy is to increase the force, and this has the surprising consequence that it moves the position of the levitating device near the top, where a lower force is required.

Thus the system compensates for these conditions.

When the item is over the base, it is detected by H3, and a switch 61 is opened, producing a signal proportional to the force is transmitted through a resistor 63 and makes a current that charges the 2 capacitors connected to the positive side of the amplifier, in order to increase this force.

After a time period, in this case a few seconds, the force is reduced to 0, the item has reached the top of the magnetic potential energy, and no average current crosses the coils any more. This realises the dream of Earnshaw theorem over passing: no energy is required any more to stabilise the magnetic levitation, except for the sensors.

FIG. 6 describes the better arrangement to detect the position of the item by utilizing the 2 Hall Effect sensors H1 and H2.

The issue with Hall Effect sensor detection is to detect the position of the magnet, and to suppress the influence of the field emitted by the 2 coils on this measurement. If this suppression is efficient, then the gain of the amplifier can be high without the risk of some unexpected feedback which can cause oscillations.

It appears that the sum of the 2 signals of those sensors gives the magnet position in one axis, but this sum eliminates the field contribution of the coils. The fine balance to completely eliminate the field's contribution of the coils is realized by the potentiometer 65. Then, the gain of the amplifier stage can reach 1000 with no risk of instability.

Due to this arrangement, no current cross the coils when the item is levitating, it requires a very low power, and a long autonomy with the batteries, or a autonomous operation, for example, solar cells.

D66 and D67 help the user to set up the levitating item and to identify the position of the top, where no diode is lightened.

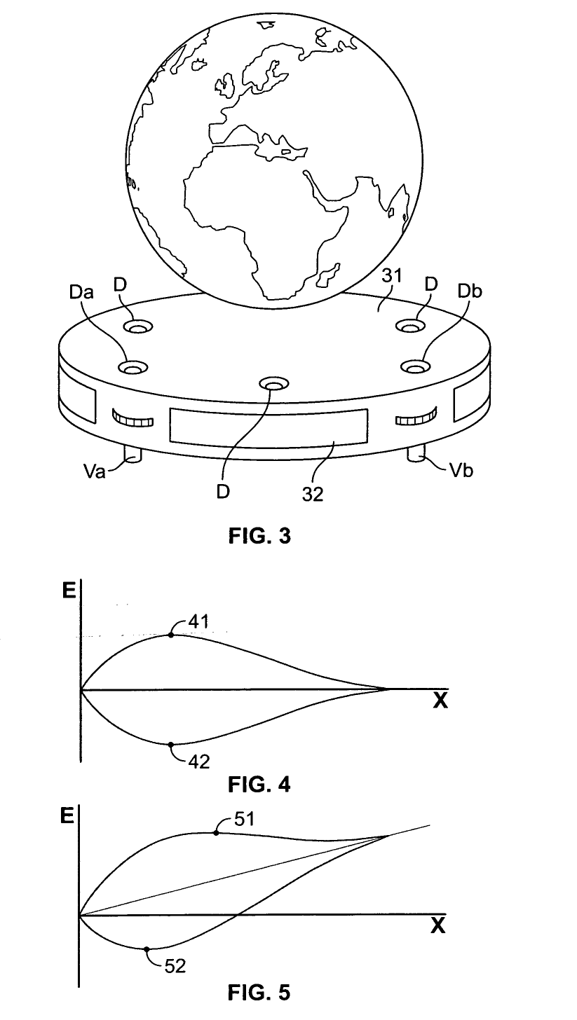

For example, with standard AA batteries, the system is capable of operating greater than six months. Moreover, one solar cell (32 FIG. 3 and 27 FIG. 2), associated with a battery 28, provides on average a power of approximately 90 mW for a surface of one square decimetre. The circuit requires on the average approximately 0.6×6 V=3.6 mW in order to work, thus allowing the system to be powered by the call.

The difference is thus sufficient to ensure power production requirements of the base without another source of energy. But a battery reloaded and maintained loaded some by the photosensitive cell contributes to provide the power necessary to the resetting of equilibrium if it is disturbed.

The electronics equipped with Hall Effect probe consumes 15 mA under 6 volts, that is to say 90 mW. It can be maintained by a 1 dm² solar cell.

According to this basic exemplary embodiment, two electromagnets are used, and in the case of 2 they are placed in the center in a cross arrangement and with a horizontal axis.

According to this basic exemplary embodiment, at least 2 force sensors are used.

According to this basic exemplary embodiment using of the Hall Effect sensors, there are at least 2 sensors. Two perpendicular Hall Effect sensors placed at the center are sufficient, in combination, with two horizontal electromagnets of axis.

According to this basic exemplary embodiment, at least two of the amplifier circuits are used. According to this basic exemplary embodiment, at least 6 amplifier circuits control power transistors.

According to a version of this basic exemplary embodiment, the circuit amplifiers comprise a device of power switching, and a device of commutation of the signals of the probes, intended to insulate the probes when the electromagnets are supplied in order to avoid undesirable feedbacks.

### 2—Translational Stability Along the Vertical Axis and One Horizontal Axis, Translational Instability Along the Perpendicular Horizontal Axis

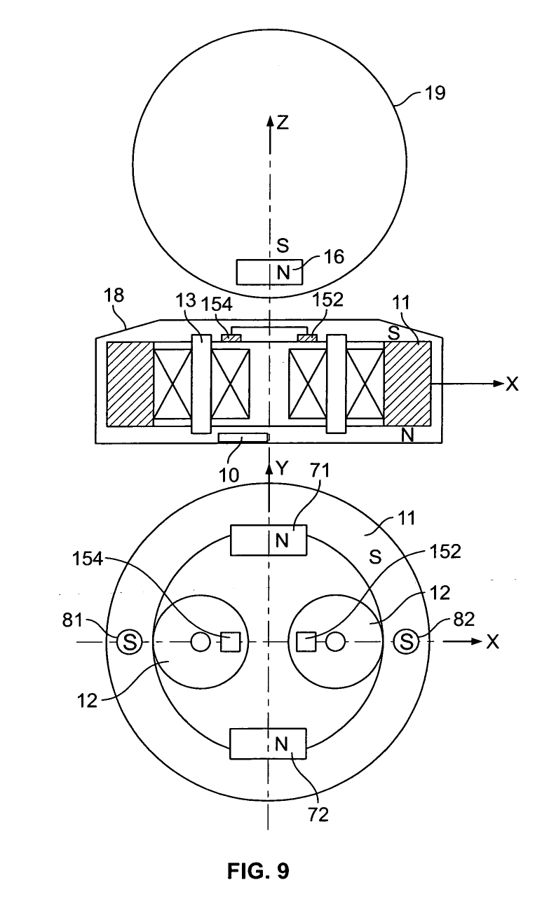

The preceding case 1 may be suppressed in one of the horizontal directions through addition of two symmetrical magnets as the 71 and 72 on FIG. 9 with polarities opposite to that of crown 11 at the base level. The north repulsion creates then a “hallway” potential cavity for magnet 16 which is large enough to alternate from instability to stability in the “y” direction, inverting however neither the turn over nor the vertical stabilities. The “hallway” effect is achieved, for example, by magnets 81 and 82.

The electromagnets 12 in the x direction, driven from Hall sensors 154 and 152, are enough to control the levitating item following the principle of FIG. 8. As provided in the preceding case 1, the electromagnets can be horizontal, which in this case 2 is equivalent to one horizontal electromagnet. The Hall sensors can be a single unit and in a place and orientation such as it is not sensitive to the field of the electromagnet. The numbers of other sensors quoted above for the case 1 are similarly reduced when passing from a two-dimensional to a one-dimensional instability.

As provided above, the levitating set of magnets must have a cylindrical symmetry when one wants the free rotation of the levitating item.

### 3. Translational Stability Along the Horizontal Axes, Translational Instability Along the Vertical Axis

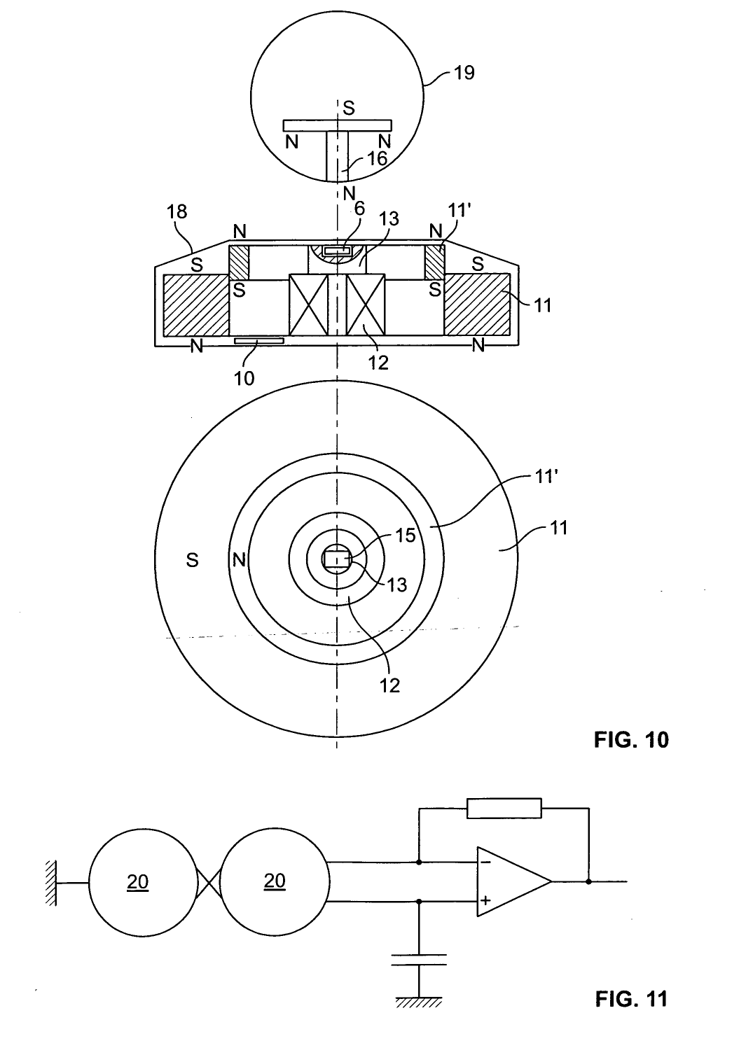

In this exemplary embodiment, instead of the two magnets 71 and 72 of the preceding case 2, a full crown 11 (on FIG. 10) at the base level, with polarities opposite to that of crown 11 and with a diameter substantially smaller. A magnetic rod is added to magnet 16 of the preceding cases with same polarity. This arrangement allows the equilibrium point to be stable for the translation along the two horizontal axes while preserving the turn over stability. According to equation (1), this equilibrium point is thus instable in the vertical direction.

The types of sensors mentioned for cases 1 and 2 remain appropriate for this exemplary embodiment except for the pressure sensors. Only one vertical electromagnet 12 (FIG. 10) is useful. In this case 3 a horizontal electromagnet cannot operate.

The minimum number of sensors is the same as in case 2. This embodiment uses two Hall Effect sensors in order to eliminate the influence of the electromagnet on them.

Contrarily to cases 1 and 2, the height of levitation versus levitating total mass does not decrease but rather reaches a maximum for a mass depending on the set of base and levitating magnets.

The inversion of stability method:

According to preferred embodiments of the invention, one does not add in equation (2) a corrective force ∂C/∂X depending on X as explained above, but two corrective forces as follows: K, positively proportional to the acceleration of the item, and L positively proportional to the velocity of said item:
K=k∂²X/∂t² (5) and
F=f∂X/∂t (6)

Then (2) becomes
m∂²X/∂t²=k∂²X/∂t²=∂E/∂X+D+F+R and thus
(m−k)∂²X/∂t²=−∂E/∂X+D+F+R

Now if k<m, the instability becomes greater with increasing k and f, since the levitating item basically behaves as if it was lighter and lighter. But when k>m, the instable potential plays the role of a stable potential; if moreover F>−D then the stability inversion is achieved: the levitating item returns to the point X=0, its motion is dampened, and the random perturbations R do not modify the situation more than in a usual stable equilibrium.

For adding in the current of the electromagnets 12 a term F such as F>−D, considering the usual good approximation (3) of D, one just chooses the value of f>a in equation (6).

The first advantage of the present invention is that the stabilizing device does not use more energy than what is required for correcting random perturbations and for the sensors measuring the position of the item.

The second advantage is that sensors are used to measure the derivative of X (Y or Z) instead of X (Y or Z). If one uses coils 20 (FIG. 11), for instance, then for each direction, X Y or Z, a coil is sufficient, and a pair of coils allows preventing the influence of the electromagnets 12 when the coils are positioned with the proper symmetry.

FIG. 11 is a principle electronic schema giving the sum of the signal measured by a pair of coils and its derivative.

According to an other preferred embodiments of the invention, the average current in the coil can be cancelled by the action of the combination of resistor 29 and capacitor 26. The slave system compensates the position of the levitating item over the base and delivers a current in the coil. The levitating item is maintained near the top of the magnet field repulsion, and the direction of the force is pointed to the top. The resistor 29 is arranged to modify the voltage of the reference after a delay, this is increasing the force. By this automatic processing, the levitating device is reaches the top of the magnetic field repulsion. At the top, there is a metastable point of equilibrium, where the slave does not pull back the levitating item.

This resistor 29, which usually makes the slave system unstable, helps, in fact, in this particular case the device to find a metastable balance point at the top of the magnetic repulsion field, where no energy is required. This is a very surprising effect and concept of this invention: Unstable electronic processing can stabilize unstable magnetic system with no average energy consumption.

Permanent Rotation of the Levitating Item

A dissymmetry in the levitating set of magnets 16 can be introduced by adding small magnets to said set 16 or by a shift of its center of symmetry relatively to the center of gravity of the overall levitating item 19. In the latter case its dissymmetry is simply due to its tilt.

Such a dissymmetry gives to the sensors 15 a signal S corresponding to the rotation of the levitating item.

Moreover such a dissymmetry is submitted to a couple of forces from the pairs (FIG. 8) of electromagnets 12 when said pairs are submitted to said signal S. In return, the rotation of the dissymmetrical item 19 influences the sensors 15 and thus the electromagnets 12. Consequently, the dissymmetry causes the permanent rotation of the levitating item through the square of its value, provided that this dissymmetry is large enough as follows:

As provided above, the combined lack of cylindrical symmetry for both levitating and base sets of magnets prevents a fully free rotation of the item 19. The item 19 overcomes this rotational potential provided its average rotational kinetic energy is large enough, and the upkeep of this kinetic energy dissipated by the air viscosity is given by a sufficient cylindrical dissymmetry of the levitating ensemble as explained above.

In the exemplary embodiment, a rotation period of a few seconds is achieved that is sufficient to overcome the usual magnetic dissymmetry of ferrite crowns 11 commercially available for the base.

This rotation is more difficult to achieve in case 2, because the strong base dissymmetry gives a strong rotational potential, and in case 3, because of the weakness of the couple the central electromagnet 12 can exert on the levitating magnets.

According to a nonexclusive exemplary embodiment the invention, the top outside of base 1 (18 FIG. 1 and 31 FIG. 3) is a curved mirror. This mirror reinforces the subjective height of the levitating item and makes easy to see underneath it.

According to a nonexclusive exemplary embodiment the invention, the top outside of base 1 (18 FIG. 1 and 31 FIG. 3) is a holographic image, the apparent item of it in under the plate. This holographic image reinforces then the perception of height of the levitating item, especially when said apparent item is located at infinity like stars, planets, moon etc. According to the invention, and without any limit; the levitating item is for example a globe, a statue of Buddha, a container, support of various items.

Conclusions

The levitating item may be of a heavy appearance different than conventional systems. The levitating item is completely motionless when equilibrium is adjusted. The levitating item and the base are quiet. The surface representing the ground is a plane or at least regular. The space above the plan of the ground and around the item is free and empty of any device. The arrangements used for levitation are discreet if not unperceivable. The levitation is permanent, autonomous over a long duration from the point of view energy, or fed from a low power converter. The levitating item turns freely around the vertical axis or a tilted axis, and this rotation may be assisted.

What is claimed is:

1. A device to produce magnetic levitation, comprising:
a base; and
an item wherein the item levitates over the base in a stable arrangement without turning over, wherein the item is positioned entirely above the base, and the base is configured to be entirely under a group of two parallel horizontal planes that are separated by a distance.

2. The device according to claim 1, wherein the base is electrically operated.

3. The device according to claim 1, wherein the base is supplied electricity by a lower power electric converter.

4. The device according to claim 1, wherein the item turns on one of a vertical and a tilted axis.

5. The device according to claim 1, wherein the base comprises:
at least one permanent lifting magnet distributed in a crown having an approximately cylindrical symmetry.

6. The device according to claim 1, further comprising:
one or more permanent magnets positioned in the item, wherein the item has a field with a cylindrical symmetry at least when the base does not have a cylindrical symmetry.

7. The device according to claim 6, wherein the magnets of the item are directed such that a magnetic field produced by the magnets pushes against an arrangement of magnets in the base an amount exactly equal to a weight of the item at a specific height.

8. The device according to claim 6, wherein the magnets of the item are stable in rotation around a horizontal axis to ensure a stable orientation of the item.

9. The device according to claim 6, wherein the magnets of the item are unstable in translation along at least one axis but stabilized by a control device, wherein the control device has a number of sensors as a number of axes of instability, wherein the sensors measure a displacement of a center of gravity of the item along the axes of instability relative to the base and the control device has at least as many independent processing circuits as a number of axes of instability, driven from signals from the sensors that control current to the magnets configured as electromagnets and at least as many independent windings as the number of axes of instability forming the electromagnets that generate the magnetic fields, wherein the magnetic fields generated correct for displacements of the item to bring the item back to an equilibrium point by acting on the magnets of the item.

10. The device according to claim 9,wherein the electromagnets have a core that is prevented from saturation by setting at least one magnetic rod parallel one of parallel to the core, as close to a corresponding winding as possible, and when a polarity cancels or diminishes a polarity of the core.

11. The device according to claim 1, wherein the item is one of in free rotation and maintained in rotation around a vertical axis due to a cylindrical symmetry of at least one of a levitating set of magnets and a base set of magnets, a tilt of the vertical axis produced by a cylindrical dissymmetry of the base set of magnets.

12. The device according to claim 11, wherein the items set of magnets has a cylindrical dissymmetry such that the base magnets set the item in rotation.

13. The device according to claim 9, wherein the sensor delivers a signal essentially proportional to a variation of a position of the item compared to an axis of the base, wherein the sensor is one of a magnetic sensor for a probe measuring the Hall Effect, a strain gauge sensor, a polymer with a variable resistor.

14. The device according to claim 9, wherein the sensor delivers a signal essentially proportional to a derivative versus time of a position of the item.

15. The device according to claim 13, wherein each processing circuit comprises an amplifier, a filter and transistors of power.

16. The device according to claim 15, wherein the control device comprises a damping of oscillation by an arrangement of a derivative filter device.

17. The device according to claim 15, wherein the control device comprises diodes configured to produce the non-equilibrium of the item in the horizontal plane.

18. The device according to claim 17, wherein the base is configured with adjustments to compensate for permanent non-equilibrium.

19. The device according to claim 17, wherein the electronic is configured with automatic compensation for permanent non-equilibrium in order to suppress average consumption of the coils.

20. The device according to claim 14, wherein a corrective forced produced by the electromagnets is a sum of two terms, wherein a first is proportional to an acceleration of the levitating item and has at least an intensity necessary to produce an inversion of stability and a second is proportional to a dampening of the item and has an opposite direction, and has an intensity necessary to get a dampened inversion of stability.

21. The device according to claim 9, wherein a corrective force produced by the electromagnets is in proportion with a difference of one of proportional to a position of the levitating item, plus one proportional to a speed of the levitating item minus one proportional to an integral of the force.

22. The device according to claim 9, wherein the base is autonomous due to at least one of batteries and a photoelectric cell, and wherein the sensors and the amplifiers are of a low electric power consumption.

23. The device according to claim 13 where in the signal of position is delivered by at least 2 sensors, and mixed in a potentiometer, in order that the signal is not affected by the field of the coils.

24. The device according to claim 1, wherein a base surface is a mirror that enables a user to view an underside of the item.

25. The device according to claim 1, wherein a base surface projects a hologram.
